(19) United States
(12) Patent Application Publication
(10) Pub. No.: US 2026/0323296 A1
(43) Pub. Date: Oct. 15, 2026

(54) METHODS AND APPARATUS OF PERFORMANCE MEASUREMENT FUNCTION PROTOCOL PROCEDURE UTILIZING EVOLVED PACKET DATA GATEWAY IN MOBILE COMMUNICATIONS

(71) Applicant: MEDIATEK INC., Hsinchu City (TW)

(72) Inventors: Yu-Hsin LIN, Hsinchu City (TW); Yuan-Chieh LIN, Hsinchu City (TW); Tze Jie TAN, Hsinchu City (TW); Hsin-Jun TANG, Hsinchu City (TW); Chia-Lin LAI, Hsinchu City (TW)

(73) Assignee: MEDIATEK INC., Hsinchu City (TW)

(21) Appl. No.: 19/473,791

(22) PCT Filed: Nov. 6, 2024
(86) PCT No.: PCT/CN2024/130062

§ 371 Date: Oct. 8, 2025

Related U.S. Application Data
(60) Provisional application No. 63/596,333, filed on Nov. 6, 2023.

(51) Int. Cl. H04W 12/088; H04W 76/12

(52) U.S. Cl. CPC H04W 12/088; H04W 76/12

(57) ABSTRACT

Various solutions for performance measurement function protocol (PMFP) procedure utilizing evolved packet data gateway (ePDG) with respect to user equipment (UE) and network apparatus in mobile communications are described. A UE may establish a packet data network (PDN) connection over untrusted non-3GPP access network as a user-plane resource of a multi-access (MA) data session. The UE may transmit a PMFP request message associated with a PMFP procedure to the network apparatus. The UE may count uplink (UL) packets sent over an entire of the PDN connection. The UE may receive a PMFP report message from the network apparatus. The PMFP report message may include a number of received UL packets counted over all bearers of the PDN connection by the network apparatus. So that the packet counting granularity is aligned between the UE and the network apparatus.

### CROSS REFERENCE TO RELATED PATENT APPLICATION(S)

The present disclosure is part of a non-provisional application claiming the priority benefit of U.S. Patent Application No. 63/596,333, filed 6 Nov. 2023, the content of which herein being incorporated by reference in its entirety.

### TECHNICAL FIELD

The present disclosure is generally related to mobile communications and, more particularly, to performance measurement function protocol (PMFP) procedure utilizing evolved packet data gateway (ePDG) with respect to user equipment and network apparatus in mobile communications.

### BACKGROUND

Unless otherwise indicated herein, approaches described in this section are not prior art to the claims listed below and are not admitted as prior art by inclusion in this section.

Access Traffic Steering, Switching and Splitting (ATSSS) is a feature in the 3rd generation partnership project (3GPP) standards, which enables traffic steering across multiple accesses, including a 3GPP access (e.g., fifth generation (5G) cellular network) and a non-3GPP access (e.g., WiFi network). The ATSSS capable user equipment (UE) may establish a packet data network (PDN) connection over untrusted non-3GPP access network as a user-plane resource of a multi-access protocol data unit (MA PDU) session. At the same time, the MA PDU session may optionally have established user plane resources over 3GPP access. An interface called evolved packet data gateway (ePDG) is used between the 5G core network and untrusted non-3GPP access networks to provide the functionalities such as access control, data forwarding, security, mobile management, and quality of service (QOS) management. In 3GPP Release 18, two scenarios are provided for ePDG. In one scenario, only one internet protocol security (IPsec) security association (SA) is established between the UE and the ePDG and it transports traffic for the default bearer and all dedicated bearers established over S2b between the ePDG and the packet data network gateway (PDN-GW). In the second scenario, when the UE and the ePDG supports the establishment of a separate IPsec child SA per dedicated S2b bearer that transports the traffic for that dedicated bearer, and where the main IPSec SA transports the traffic for the default bearer. As the PDN-GW is unaware of which scenario is used by the ePDG, some performance measurement function protocol (PMFP) procedures related to packets counting may not execute correctly at the UE and network sides. Therefore, there is a need to provide proper schemes to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to performance measurement function protocol (PMFP) procedure utilizing evolved packet data gateway (ePDG) with respect to user equipment (UE) and network apparatus in mobile communications.

In one aspect, a method may involve an apparatus establishing a packet data network (PDN) connection. The method may also involve the apparatus transmitting a PMFP request message associated with a PMFP procedure to a network node. The method may also involve the apparatus counting uplink (UL) packets sent over an entire of the PDN connection. The method may further involve the apparatus receiving a PMFP report message from the network node. The PMFP report message may include a number of received UL packets counted by the network node.

In one aspect, an apparatus may comprise a transceiver which, during operation, wirelessly communicates with a network node. The apparatus may also comprise a processor communicatively coupled to the transceiver. The processor, during operation, may perform operations comprising establishing a PDN connection via the transceiver. The processor may also perform operations comprising transmitting a PMFP request message associated with a PMFP procedure to a network node via the transceiver. The processor may also perform operations comprising counting UL packets sent over an entire of the PDN connection. The processor may further perform operations comprising receiving a PMFP report message from the network node via the transceiver. The PMFP report message may include a number of received UL packets counted by the network node.

In another aspect, a method may involve a network node transmitting a PMFP request message associated with a PMFP procedure to a UE. The method may also involve the network node counting downlink (DL) packets sent over an entire of a PDN connection. The method may further involve the network node receiving a PMFP report message from the UE. The PMFP report message may include a number of received DL packets counted by the UE.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2A is a diagram depicting an example scenario of single IPSec SA per PDN connection in accordance with implementations of the present disclosure.

FIG. 2B is a diagram depicting an example scenario of single IPSec SA per S2b bearer in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to performance measurement function protocol (PMFP) procedure when using evolved packet data gateway (ePDG) in mobile communications, ensuring that the packet counting granularity is aligned between the UE and network sides. According to the present disclosure, a number of possible solutions may be implemented separately or jointly. That is, although these possible solutions may be described below separately, two or more of these possible solutions may be implemented in one combination or another.

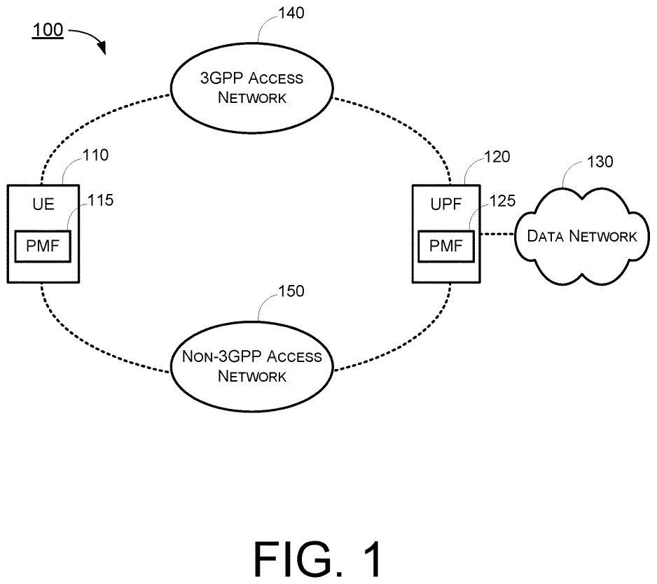

FIG. 1 is a diagram depicting an example scenario of a communication environment in which various solutions and schemes in accordance with the present disclosure may be implemented. In scenario 100, Access Traffic Steering, Switching and Splitting (ATSSS) functionalities can be supported by a UE 110 and a user plane function (UPF) 120. The ATSSS functionalities enable a multi-access protocol data unit (MA PDU) connectivity service, which can exchange PDUs between the UE 110 and a data network 130 by simultaneously using a 3rd generation partnership project (3GPP) access network 140 and a non-3GPP access network 150. The MA PDU connectivity service is realized by establishing a MA PDU session. That is, a PDU session that can have user-plane resources on both of the 3GPP access network 140 and the non-3GPP access network 150. In one embodiment, the 3GPP access network 140 may comprise one or more base stations (e.g., gNBs/eNBs) providing radio access for the UE 110 via various 3GPP radio access technologies (RATs) including but not limited to 6G, 5G, 4G, and 3G/2G, where the non-3GPP access network 150 may comprise access points (APs) providing radio access for UE 110 via non-3GPP RAT, such as WiFi. For non-3GPP access, an evolved packet data gateway (ePDG) acts as a key intermediary in cellular networks (e.g., LTE/5G network), ensuring secure and seamless connectivity between the cellular core network and the non-3GPP access network 150.

In scenario 100, the PMFP procedures may be performed between a performance measurement function (PMF) 115 in the UE 110 and a PMF 125 in the UPF 120 to measure the performance between the PMFs 115 and 125. The PMFP procedure may be performed over the ePDG leg and/or cellular leg (e.g., 3GPP NR leg, packet data network (PDN) leg). For example, when a PDN connection is established over an untrusted non-3GPP access network (e.g., the non-3GPP access network 150) as a user-plane resource of a multi-access data session (i.e., the MA PDU session), a PMFP procedures called a packet loss rate (PLR) measurement procedure may be initiated by the PMF 115 as well as the PMF 125. In one embodiment, the PLR measurement may be performed over the whole PDN connection. To be specific, there are two scenarios provided for untrusted non-3GPP access using the ePDG, but the UPF 120 and the PGW-U are unaware of which scenario is used by the ePDG. Besides, due to the inability of the UE 110 to identify the bearer or internet protocol security (IPsec) security association (SA) used for a PMFP procedure, the UE 110 is unable to count packets sent/received over specific IPSec SA/bearer. To ensure the accurate execution of PMFP procedures related to packet counting, it is needed to maintain consistent packet counting granularity between UE 110 and UPF 120. For example, in the PLR measurement procedure, the UE 110 and the UPF 120 may count the packets sent/received over the whole PDN connection. That is, the UE 110 and the UPF 120 may count all packets send/received over the SWu instance/all IPsec SA/all S2b bearers. Further, the UE 110 and the UPF 120 may send the PMFP message over the default bearer of the PDN connection. In one embodiment, the UE 110 and the UPF 120 may perform the PMFP procedures other than the PLR measurement procedure over a default S2b bearer or a default IPSec SA of the PDN connection. For example, when utilizing the ePDG leg, for the round trip time (RTT) measurement procedure, the PMFP messages are only sent over the default bearer of the PDN connection (e.g., IPsec tunnel of the default bearer and the default S2b bearer of the PDN connection).

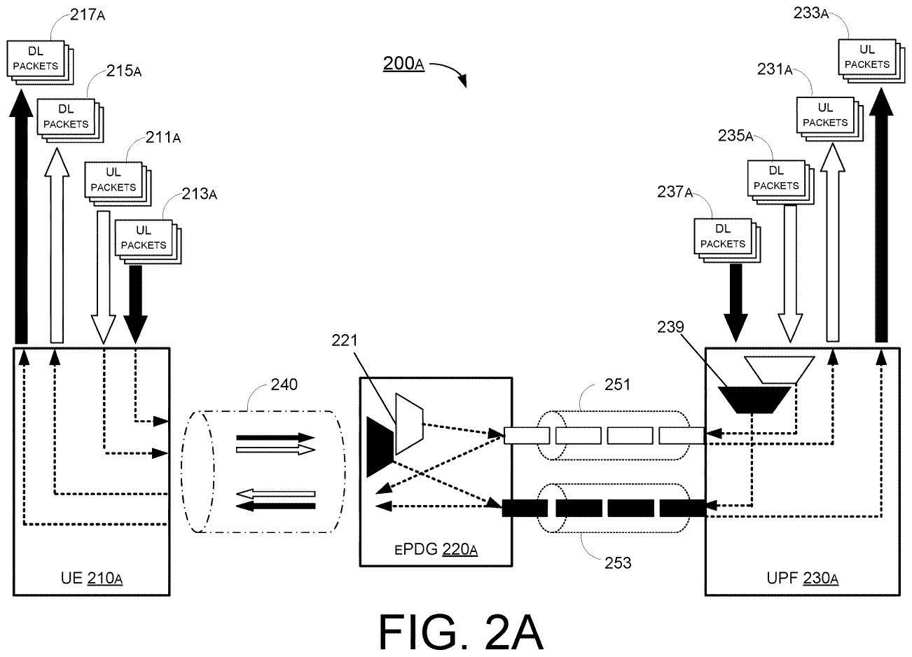

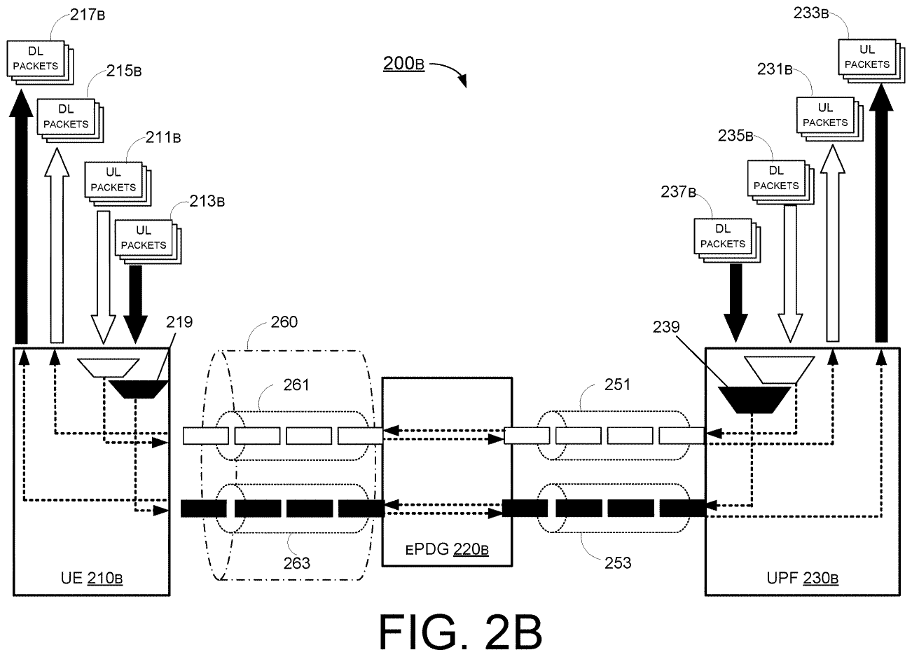

FIG. 2A is a diagram depicting an example scenario of single IPSec SA per PDN connection in accordance with implementations of the present disclosure. In scenario 200a, only one IPSec SA is established between the UE 210a and the ePDG 220a and it transports traffic for the default bearer and all dedicated bearers established over S2b between the ePDG 220a and the UPF 230/the related PDN Gateway. In one embodiment, after the UE 210a establishes a PDN connection over the untrusted non-3GPP access network as a user-plane resource of a multi-access data session, the UE 210a may transmit a PMFP PLR count request message associated with the PLR measurement procedure to the UPF 230a. For example, the PMFP PLR count request message and other PMFP messages associated with the PLR measurement procedure from the UE 210a may be transmitted over an IPsec tunnel of default bearer context of the PDN connection.

Upon sending the PMFP PLR count request message, the UE 210a starts counting the transmitted uplink (UL) packets over the entire of the PDN connection. The entire of the PDN connection may include all IPsec tunnels of the PDN connection. For example, assuming that the number of the UL packets 211a sent over the IPsec tunnel 240 is 100 and the number of the UL packets 213a sent over the IPsec tunnel 240 is 50, the counting result derived by the UE 210a is 150 (i.e., 100+50).

On the other hand, upon receiving the PMFP PLR count request message from the UE 210a, the UPF 230a starts counting the received UL packets over all bearers of the PDN connection and send the PMFP PLR report response message including the counting result back to the UE 210a. For example, the UL packets 211a sent over the IPsec tunnel 240 are filtered by the UL packet filter 221 in the ePDG 220a and transmitted to the UPF 230a through the S2b bearer 251. Also, the UL packets 213a sent over the IPsec tunnel 240 are filtered by the UL packet filter 221 and transmitted to the UPF 230a through the S2b bearer 253. Assuming that the number of the received UL packets 231a corresponding to the UL packets 211a is 95, and the number of the received UL packets 233a corresponding to the UL packets 213a is 50, the counting result to be included in the PMFP PLR report response message is 145 (i.e., 95+50). Then, the UE 210a may calculate the UL packet loss rate based on the local counting result (i.e., 150) and the number reported by the UPF 230a (i.e., 145).

The UPF 230a may also initiate a PLR measurement procedure by transmitting a PMFP PLR count request message to the UE 210a. For example, the PMFP PLR count request message and the other PMFP messages associated with the PLR measurement procedure from the UPF 230a may be transmitted over a default bearer of the PDN connection. Upon sending the PMFP PLR count request message, the UPF 230a starts counting the transmitted downlink (DL) packets over the entire of the PDN connection. In this embodiment, the entire of the PDN connection may include all bearers of the PDN connection (e.g., the S2b bearers 251 and 253). For example, it is assumed that the number of the DL packets 235a sent over the S2b bearer 251 is 200 and the number of the DL packets 237a sent over the S2b bearer 253 is 300, the local counting result derived by the UFP 230a is 500 (i.e., 200+300).

Upon receiving the PMFP PLR count request message, the UE 210a starts counting the received DL packets over all IPsec tunnels of the PDN connection and send the PMFP PLR report response message including the counting result back to the UPF 230a. For example, the DL packets 235a are filtered by the DL packet filter 239 and transmitted to the ePDG 220a through the S2b bearer 251, and the DL packets 237a are filtered by the DL packet filter 239 and transmitted to the ePDG 220a through the S2b bearers 253. It is assumed that the number of the received DL packets 215a corresponding to the DL packets 235a is 200, and the number of the received DL packets 217a corresponding to the DL packets 237a is 280, the counting result to be included in the PMFP PLR report response message is 480 (i.e., 200+280). Accordingly, the UPF 230a may calculate the DL packet loss rate based on the local counting result (i.e., 500) and the number reported by the UE 210a (i.e., 480).

In one embodiment, the counting of the UL or DL packets sent over the entire of the PDN connection is performed only in an event that the PDN connection corresponds to a single IPSec SA (e.g., scenario 200a). In another embodiment, the counting of the UL or DL packets sent over the entire of the PDN connection may also be performed when the PDN connection corresponds to multiple IPSec SAs.

FIG. 2B is a diagram depicting an example scenario of single IPSec SA per S2b bearer in accordance with implementations of the present disclosure. In scenario 200b, the UE 210b and the ePDG 220b support the establishment of a separate IPsec child SA per dedicated S2b bearer that transports the traffic for that dedicated bearer, and a main (default) IPSec SA transports the traffic for the default bearer. The UE 210b may establish a PDN connection over the untrusted non-3GPP access network as a user-plane resource of a multi-access data session, and transmit a PMFP PLR count request message associated with the PLR measurement procedure to the UPF 230b. In this embodiment, the PMFP PLR count request message and other PMFP messages associated with the PLR measurement procedure from the UE 210b may be transmitted over an IPsec tunnel of default bearer context of the PDN connection.

Upon sending the PMFP PLR count request message, the UE 210b starts counting the transmitted UL packets over the entire of the PDN connection. In scenario 200b, the entire of the PDN connection may include all IPsec tunnels of the PDN connection, such as the IPsec tunnels 261 and 263 associated with the SWu instance 260. For example, assuming that the number of the UL packets 211b sent over the IPsec tunnel 261 is 200 and the number of the UL packets 213b sent over the IPsec tunnel 263 is 100, the counting result derived by the UE 210b is 300 (i.e., 200+100).

Upon receiving the PMFP PLR count request message, the UPF 230b starts counting the received UL packets over all bearers of the PDN connection and send the PMFP PLR report response message including the counting result back to the UE 210b. For example, the UL packets 211b are filtered by the UL packet filter 219, sent over the IPsec tunnel 261, and transmitted to the UPF 230b through the S2b bearer 251. The UL packets 213b are filtered by the UL packet filter 219, sent over the IPsec tunnel 263, transmitted to the UPF 230b through the S2b bearer 253. Assuming that the number of the received UL packets 231b corresponding to the UL packets 211b is 200, and the number of the received UL packets 233b corresponding to the UL packets 213b is 95, the counting result to be included in the PMFP PLR report response message is 295 (i.e., 200+95). Then, the UE 210b may calculate the UL packet loss rate based on the local counting result (i.e., 300) and the number reported by the UPF 230b (i.e., 295).

On the other hand, the UPF 230b may also initiate a PLR measurement procedure by transmitting a PMFP PLR count request message to the UE 210b. For example, the PMFP PLR count request message may be transmitted over a default bearer of the PDN connection. Upon sending the PMFP PLR count request message, the UPF 230b starts counting the transmitted DL packets over the entire of the PDN connection. In scenario 200b, the entire of the PDN connection may include all bearers of the PDN connection (e.g., the S2b bearers 251 and 253). It is assumed that the number of the DL packets 235b sent over the S2b bearer 251 is 300 and the number of the DL packets 237b sent over the S2b bearer 253 is 100, the local counting result derived by the UPF 230b is 400 (i.e., 300+100).

Upon receiving the PMFP PLR count request message, the UE 210b starts counting the received DL packets over all IPsec tunnels of the PDN connection and send the PMFP PLR report response message including the counting result back to the UPF 230b. For example, the DL packets 235b are filtered by the DL packet filter 239 and transmitted to the ePDG 220b through the S2b bearers 251, while the DL packets 237b are filtered by the DL packet filter 239 and transmitted to the ePDG 220b through the S2b bearers 253. It is assumed that the number of the received DL packets 215b corresponding to the DL packets 235b is 250, and the number of the received DL packets 217b corresponding to the DL packets 237b is 100, the counting result to be included in the PMFP PLR report response message is 350 (i.e., 250+100). Accordingly, the UPF 230b may calculate the DL packet loss rate based on the local counting result (i.e., 400) and the number reported by the UE 210b (i.e., 350).

By ensuring consistent packet counting granularity between the UE and network sides, the robust operation of the PMFP procedure (e.g., the PLR measurement procedure) when ePDG is used can be achieved.

### Illustrative Implementations

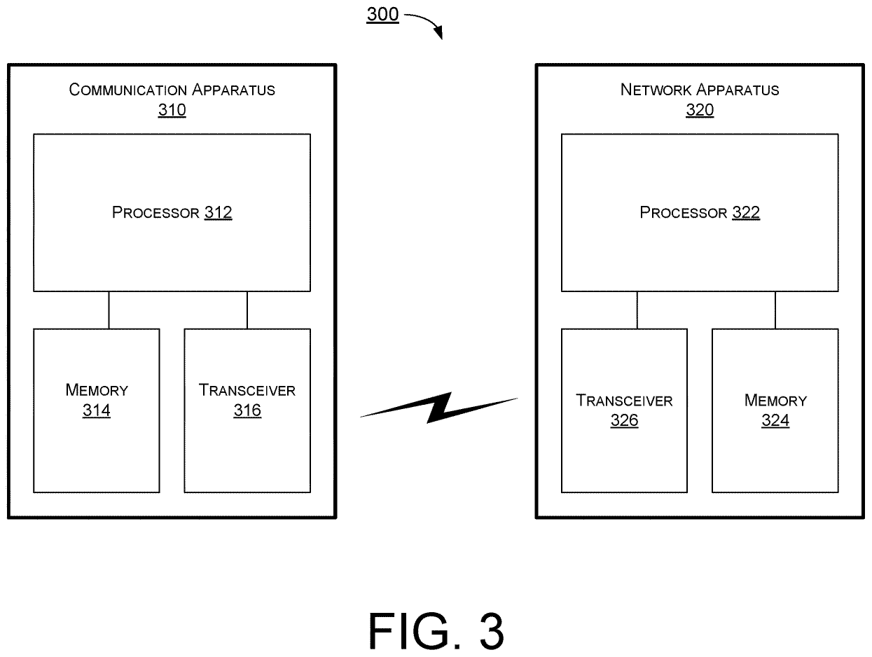

FIG. 3 illustrates an example communication system 300 having at least an example communication apparatus 310 and an example network apparatus 320 in accordance with an implementation of the present disclosure. Each of the communication apparatus 310 and network apparatus 320 may perform various functions to implement schemes, techniques, processes and methods described herein pertaining to PMFP procedure when ePDG is used in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a network entity supporting one or a combination of network functions (NFs). The NFs comprise, but not limited to, access and mobility management function (AMF), session management function (SMF), unified data management (UDM), and user plane function (UPF). Alternatively, network apparatus 320 may be a base station and/or a UPF. Network apparatus 320 may include at least some of those components shown in FIG. 3 such as a processor 322, for example. Processor 322 may further include protocol stacks and a set of control functional modules and circuit. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of the processor 312 and processor 322 may be implemented in the form of one or more single-core processors, one or more multi-core processors, or one or more CISC processors. That is, even though a singular term “a processor” is used herein to refer to processor 312 and processor 322, each of the processor 312 and processor 322 may include multiple processors in some implementations and a single processor in other implementations in accordance with the present disclosure. In another aspect, each of the processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and processor 322 is a special-purpose machine specifically designed, arranged and configured to perform specific tasks in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein.

In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

For illustrative purposes and without limitation, descriptions of capabilities of the communication apparatus 310 and network apparatus 320 are provided below with process 400 and process 500. In which, communication apparatus 310 is implemented in or as a communication apparatus or a UE, and network apparatus 320 is implemented in or as a network node of a communication network (e.g., a UPF).

### Illustrative Processes

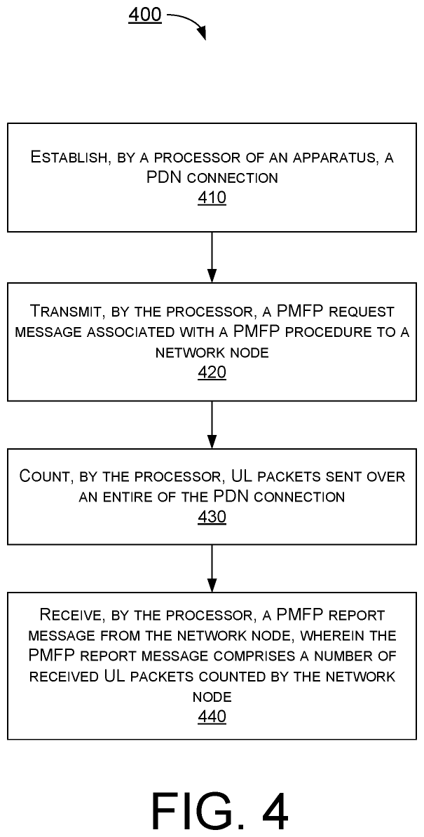

FIG. 4 illustrates an example process 400 in accordance with an implementation of the present disclosure. Process 400 may be an example implementation of above scenarios/schemes, whether partially or completely, with respect to PMFP procedure utilizing ePDG in mobile communications. Process 400 may represent an aspect of implementation of features of communication apparatus 310. Process 400 may include one or more operations, actions, or functions as illustrated by one or more of blocks 410, 420, 430, and 440. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE (e.g., the UE 110, 210a, or 210b) or machine type devices. Solely for illustrative purposes and without limitation, process 400 is described below in the context of communication apparatus 310 as a UE. Process 400 may begin at block 410.

At block 410, process 400 may involve processor 312 of communication apparatus 310 establishing a PDN connection via transceiver 316. Process 400 may proceed from block 410 to block 420.

At block 420, process 400 may involve processor 312 transmitting, via transceiver 316, a PMFP request message associated with a PMFP procedure to a network node (e.g., the UPF 120, 230a, or 230b, or network apparatus 320). Process 400 may proceed from block 420 to block 430.

At block 430, process 400 may involve processor 312 counting UL packets sent over an entire of the PDN connection. Process 400 may proceed from block 430 to block 440.

At block 440, process 400 may involve processor 312 receiving, via transceiver 316, a PMFP report message from the network node. The received PMFP report message may include a number of received UL packets counted by the network node.

In some implementations, the PDN connection is established over untrusted non-3GPP access network as a user-plane resource of a multi-access data session.

In some implementations, the entire of the PDN connection may include all IPsec tunnels of the PDN connection.

In some implementations, the number of received UL packets may be counted over all bearers of the PDN connection.

In some implementations, at least one bearer of the PDN connection may include an S2b bearer.

In some implementations, the PMFP procedure may be performed over at least one of an ePDG leg and a cellular leg.

In some implementations, the PMFP request message may be transmitted over an IPsec tunnel of default bearer context of the PDN connection.

In some implementations, the counting of the UL packets sent over the entire of the PDN connection is performed only in an event that the PDN connection corresponds to a single IPSec SA.

In some implementations, the PMFP procedure may include a PLR measurement procedure, the PMFP request message may include a PMFP PLR count request message, and the PMFP report message may include a PMFP PLR report response message.

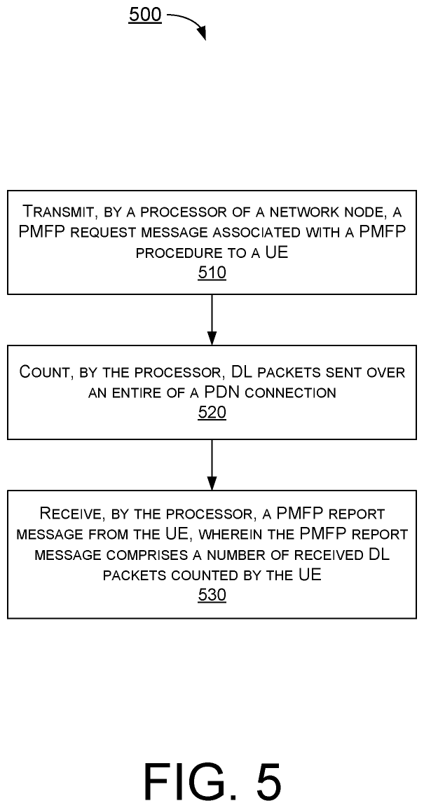

FIG. 5 illustrates another example process 500 in accordance with an implementation of the present disclosure. Process 500 may be an example implementation of above scenarios/schemes, whether partially or completely, with respect to PMFP procedure when ePDG is used in mobile communications. Process 500 may represent an aspect of implementation of features of network apparatus 320 or any suitable network node (e.g., the UPF 120, 230a, or 230b). Process 500 may include one or more operations, actions, or functions as illustrated by one or more of blocks 510, 520, and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may begin at block 510.

At block 510, process 500 may involve processor 322 of network apparatus 320 transmitting, via transceiver 326, a PMFP request message associated with a PMFP procedure to a UE (e.g., the UE 110, 210a, or 210b, or communication apparatus 310). Process 500 may proceed from block 510 to block 520.

At block 520, process 500 may involve processor 322 counting DL packets sent over an entire of a PDN connection. Process 500 may proceed from block 520 to block 530.

At block 530, process 500 may involve processor 322 receiving, via transceiver 326, a PMFP report message from the UE. The PMFP report message may include a number of received DL packets counted by the UE.

In some implementations, the PDN connection is established over untrusted non-3GPP access network as a user-plane resource of a multi-access data session.

In some implementations, the entire of the PDN connection may include all bearers of the PDN connection.

In some implementations, the number of received DL packets may be counted over all IPsec tunnels of the PDN connection.

In some implementations, the PMFP request message may be transmitted over a default bearer of the PDN connection.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an apparatus, a packet data network (PDN) connection;
transmitting, by the processor, a performance measurement function protocol (PMFP) request message associated with a PMFP procedure to a network node;
counting, by the processor, uplink (UL) packets sent over an entire of the PDN connection; and
receiving, by the processor, a PMFP report message from the network node, wherein the PMFP report message comprises a number of received UL packets counted by the network node.

2. The method of claim 1, wherein the PDN connection is established over untrusted non-3GPP access network as a user-plane resource of a multi-access data session.

3. The method of claim 1, wherein the entire of the PDN connection comprises all internet protocol security (IPsec) tunnels of the PDN connection.

4. The method of claim 1, wherein the number of received UL packets is counted over all bearers of the PDN connection.

5. The method of claim 4, wherein at least one bearer of the PDN connection comprises an S2b bearer.

6. The method of claim 1, wherein the PMFP request message is transmitted over an IPsec tunnel of default bearer context of the PDN connection.

7. The method of claim 1, wherein the counting of the UL packets sent over the entire of the PDN connection is performed only in an event that the PDN connection corresponds to a single IPSec security association (SA).

8. The method of claim 1, wherein the PMFP procedure comprises a packet loss rate (PLR) measurement procedure, the PMFP request message comprises a PMFP PLR count request message, and the PMFP report message comprises a PMFP PLR report response message.

9. An apparatus, comprising:
a transceiver which, during operation, communicates wirelessly; and
a processor communicatively coupled to the transceiver such that, during operation, the processor performs operations comprising:
establishing, via the transceiver, a packet data network (PDN) connection;
transmitting, via the transceiver, a performance measurement function protocol (PMFP) request message associated with a PMFP procedure to a network node;
counting uplink (UL) packets sent over an entire of the PDN connection; and
receiving, via the transceiver, a PMFP report message from the network node, wherein the PMFP report message comprises a number of received UL packets counted by the network node.

10. The apparatus of claim 9, wherein the entire of the PDN connection comprises all internet protocol security (IPsec) tunnels of the PDN connection.

11. The apparatus of claim 9, wherein the number of received UL packets is counted over all bearers of the PDN connection.

12. The apparatus of claim 11, wherein at least one bearer of the PDN connection comprises an S2b bearer.

13. The apparatus of claim 9, wherein the PMFP request message is transmitted over an IPsec tunnel of default bearer context of the PDN connection.

14. The apparatus of claim 9, wherein the counting of the UL packets sent over the entire of the PDN connection is performed only in an event that the PDN connection corresponds to a single IPSec security association (SA).

15. The apparatus of claim 9, wherein the PMFP procedure comprises a packet loss rate (PLR) measurement procedure, the PMFP request message comprises a PMFP PLR count request message, and the PMFP report message comprises a PMFP PLR report response message.

16. A method, comprising:
transmitting, by a processor of a network node, a performance measurement function protocol (PMFP) request message associated with a PMFP procedure to a user equipment (UE);
counting, by the processor, downlink (DL) packets sent over an entire of a packet data network (PDN) connection; and
receiving, by the processor, a PMFP report message from the UE, wherein the PMFP report message comprises a number of received DL packets counted by the UE.

17. The method of claim 16, wherein the PDN connection is established over untrusted non-3GPP access network as a user-plane resource of a multi-access data session.

18. The method of claim 16, wherein the entire of the PDN connection comprises all bearers of the PDN connection.

19. The method of claim 16, wherein the number of received DL packets is counted over all internet protocol security (IPsec) tunnels of the PDN connection.

20. The method of claim 16, wherein the PMFP request message is transmitted over a default bearer of the PDN connection.
